(19) United States
(12) Patent Application Publication
(10) Pub. No.: US 2015/0377337 A1
(43) Pub. Date: Dec. 31, 2015

(54) Power Transmission Device

(71) Applicant: AISIN AW CO., LTD., Anjo-shi, Aichi (JP)

(72) Inventors: Takeshi TORII, Anjo-shi (JP); Tsubasa DEGUCHI, Anjo-shi (JP); Motoshi ASANO, Anjo-shi (JP)

(73) Assignee: AISIN AW CO., LTD., Anjo-shi, Aichi-ken (JP)

(21) Appl. No.: 14/766,864

(22) PCT Filed: Feb. 25, 2014
(86) PCT No.: PCT/JP2014/054565

§ 371 Date: Aug. 10, 2015

(30) Foreign Application Priority Data
Feb. 25, 2013 (JP) 2013-034825

(51) Int. Cl. F16H 57/021; F16C 19/38; F16H 57/00

(52) U.S. Cl. CPC F16H 57/021; F16H 57/0006; F16C 19/385; F16H 2057/02047

(57) ABSTRACT

A power transmission device, including a transmission, a case member, a bearing, a counter drive gear that is coupled to an output member of the transmission, that is rotatably supported by the case member via the bearing, and that is formed by a helical gear, and a counter driven gear that meshes with the counter drive gear so that a resultant force of a radially inward force and a force in one direction in an axial direction is applied to the counter drive gear during forward traveling of a vehicle.

### BACKGROUND

The present disclosure relates to power transmission devices.

Conventionally, power transmission devices are proposed which include a speed change mechanism, a counter gear coupled to a ring gear of a planetary gear unit as an output member of the speed change mechanism and supported by a case via a bearing, and a large diameter gear fixed to a countershaft and meshing with the counter gear (see, e.g., Japanese Patent Application Publication No. 2008-121808). In such devices, the counter gear is rotatably supported by the case via the bearing configured as a double row ball bearing.

### SUMMARY

In such power transmission devices, a contact angle of rolling elements (such as balls or rollers) with outer and inner rings is typically the same in both rows of the double row bearing, and the counter gear and the large diameter gear are typically configured as helical gears. Accordingly, during traveling, the resultant force of a radially inward force and a force in one direction in an axial direction is applied from the large diameter gear to a meshing part of the counter gear with the helical gear, and a force in the other direction in the axial direction is applied as a reaction force to a part of the counter gear which is located on the opposite side from the meshing part with respect to the gear center. If the counter gear is tilted with respect to a perpendicular plane perpendicular to the axial direction due to the reaction force, gear noise is increased. It is therefore one of challenges to propose a configuration capable of further suppressing such tilting.

It is an exemplary aspect of a power transmission device of the present disclosure to propose a configuration capable of further suppressing tilting of a counter drive gear with respect to a perpendicular plane perpendicular to an axial direction.

The power transmission device of the present disclosure takes the following measures in order to achieve the above exemplary aspect.

The power transmission device according to an exemplary embodiment of the present disclosure is a power transmission device, including a transmission, a case member, a bearing, a counter drive gear that is coupled to an output member of the transmission, that is rotatably supported by the case member via the bearing, and that is formed by a helical gear, and a counter driven gear that meshes with the counter drive gear so that a resultant force of a radially inward force and a force in one direction in an axial direction is applied to the counter drive gear during forward traveling of a vehicle, wherein the bearing is provided between the counter drive gear and the case member, and includes an outer ring having an annular shape and having two rows of outer ring raceways formed on its inner periphery, an inner ring having an annular shape and having two rows of inner ring raceways formed on its outer periphery, and two rows of a plurality of rolling elements that roll between the two rows of outer ring raceways and the two rows of inner ring raceways, and the bearing is formed so that a second row contact angle of the plurality of rolling elements of a second row with the outer ring raceway and the inner ring raceway is larger than a first row contact angle of the plurality of rolling elements of a first row with the outer ring raceway and the inner ring raceway, the first row being one of the two rows which is located on a side in the one direction, and the second row being the other row different from the first row.

In the power transmission device of the present disclosure, in the configuration in which the counter drive gear meshes with the counter driven gear so that the resultant force of the radially inward force and the force in the one direction in the axial direction is applied from the counter driven gear to the counter drive gear during forward traveling of the vehicle, the bearing interposed between the counter drive gear and the case member is formed so that the second row contact angle of the plurality of rolling elements of the second row of the two rows which is different from the first row (is located on a side in the other direction in the axial direction) with the outer ring raceway of the outer ring and the inner ring raceway of the inner ring is larger than the first row contact angle of the plurality of rolling elements of the first row of the two rows which is located on the side in the one direction with the outer ring raceway of the outer ring and the inner ring raceway of the inner ring. In the configuration of the power transmission device of the present disclosure, during forward traveling of the vehicle, the resultant force of the radially inward force and the force in the one direction in the axial direction is applied from the counter driven gear to a meshing part of the counter drive gear with the counter driven gear, and a force in the other direction in the axial direction is applied as a reaction force to a part of the counter drive gear which is located on an opposite side from the meshing part with respect to a gear center (hereinafter referred to as the “opposite-side part”). Rigidity (strength) against the force in the axial direction which is applied to the counter drive gear can therefore be increased by making the second row contact angle larger than the first row contact angle. This can further suppress tilting of the counter drive gear with respect to a perpendicular plane perpendicular to the axial direction, and can achieve reduction in gear noise etc. It is preferable that the first row contact angle be a relatively small angle in order to ensure rigidity against the force in the radial direction. In the case of using a tapered roller bearing as the bearing, each of the “first row contact angle” and the “second row contact angle” refers to an angle of a straight line, which lies on a plane perpendicular to a contact line of the rolling element with the outer ring raceway and extends toward a centerline of the bearing, with respect to the radially inward direction. In the case of using a ball bearing as the bearing, each of the “first row contact angle” and the “second row contact angle” refers to an angle of a straight line, which extends through a contact point of the rolling element with the outer ring raceway and a contact point of the rolling element with the inner ring raceway and extends toward the centerline of the bearing, with respect to the radially inward direction.

In the power transmission device of the present disclosure thus configured, the plurality of rolling elements of the second row may be smaller than the plurality of rolling elements of the first row. This can further reduce the axial size of the bearing.

In the power transmission device of the present disclosure, the one direction may be a direction toward the output member of the transmission, and the output member may be formed by a helical gear, and may be subjected to a force in the other direction in the axial direction which is opposite to the one direction.

Moreover, in the power transmission device of the present disclosure, the bearing may be configured as a tapered roller bearing.

Furthermore, in the power transmission device of the present disclosure, the bearing may be configured as a double row bearing with back-to-back duplex type, and the inner ring may be fixed so that it cannot move in the axial direction with respect to the case member or the counter drive gear. In the power transmission device of the present disclosure according to this aspect, the outer ring of the bearing may be coupled to the counter drive gear, the inner ring of the bearing may be coupled to the case member, and the inner ring may be fixed so that it cannot move in the axial direction with respect to the case member. Alternatively, the outer ring of the bearing may be coupled to the case member, the inner ring of the bearing may be coupled to the counter drive gear, and the inner ring may be fixed so that it cannot move in the axial direction with respect to the counter drive gear.

### BRIEF DESCRIPTION OF THE DRAWINGS

FIG. 1 is a schematic configuration diagram of a power transmission device according to an embodiment of the present disclosure.

FIG. 2 is a partial sectional view of the power transmission device.

FIG. 3 is an operation table showing the relation between each shift speed of an automatic transmission and the operating state of clutches and brakes.

FIG. 4 is a schematic view schematically showing a ring gear of a second planetary gear mechanism, a counter drive gear, and a counter driven gear.

FIG. 5 is a partial enlarged view showing the counter drive gear and a bearing in the power transmission device.

FIG. 6 shows schematic configuration diagrams schematically showing the configuration of counter drive gears and bearings in the power transmission device of the embodiment and a power transmission device of a comparative example.

FIG. 7 is a partial enlarged view showing the counter drive gear and a bearing in a power transmission device of a modification.

FIG. 8 is a partial enlarged view showing a counter drive gear and a bearing in a power transmission device of a modification.

### DETAILED DESCRIPTION OF THE EMBODIMENTS

A mode for carrying out the present disclosure will be described below by using an embodiment.

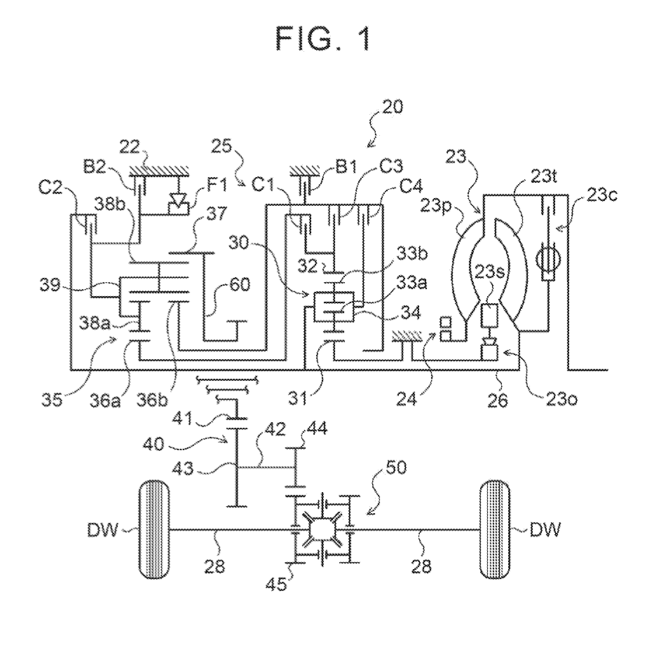

FIG. 1 is a schematic configuration diagram of a power transmission device 20 according to an embodiment of the present disclosure. The power transmission device 20 shown in the figure is connected to a crankshaft of an engine, not shown, which is mounted on a front-wheel drive vehicle, and can transmit power from the engine to right and left drive wheels (front wheels) DW. As shown in the figure, the power transmission device 20 includes a transmission case 22, and a fluid transmission device (torque converter) 23, an oil pump 24, an automatic transmission 25, a gear mechanism (gear train) 40, a differential gear (differential mechanism) 50, etc. which are accommodated in the transmission case 22.

The fluid transmission device 23 is configured as a torque converter having an input-side pump impeller 23p connected to the crankshaft of the engine, an output-side turbine runner 23t connected to an input member (input shaft) 26 of the automatic transmission 25, a stator 23s that is disposed inside the pump impeller 23p and the turbine runner 23t and that adjusts the flow of hydraulic oil from the turbine runner 23t to the pump impeller 23p, a one-way clutch 23o that limits the rotational direction of the stator 23s to one direction, a lockup clutch 23c, etc. The fluid transmission device 23 may be configured as a fluid coupling that does not have the stator 23s. The oil pump 24 is configured as a gear pump including a pump assembly comprised of a pump body and a pump cover, and an external gear connected to the pump impeller 23p of the fluid transmission device 23 via a hub. The oil pump 24 is driven by the power from the engine to suck hydraulic oil (ATF) stored in an oil pan, not shown, and pump the sucked hydraulic oil to a hydraulic control device, not shown.

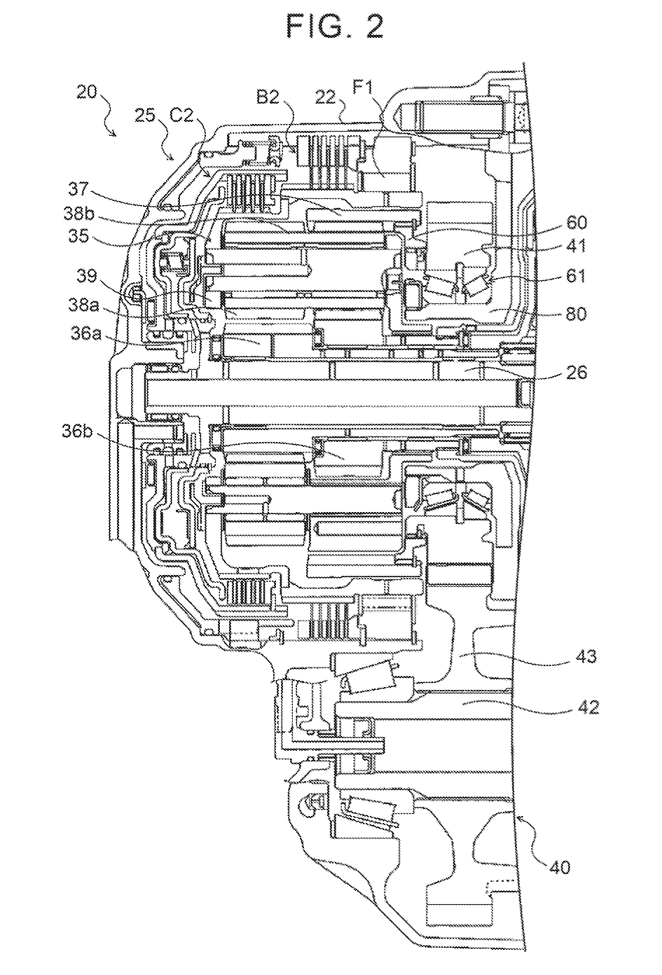

FIG. 2 is a partial sectional view of the power transmission device 20. The automatic transmission 25 is configured as an eight-speed transmission. As shown in FIGS. 1 and 2, the automatic transmission 25 includes, in addition to the input member 26, a double-pinion type first planetary gear mechanism 30, a Ravigneaux type second planetary gear mechanism 35, and four clutches C1, C2, C3, C4, two brakes B1, B2, and a one-way clutch F1 which change a power transmission path from the input side to the output side.

The first planetary gear mechanism 30 has: a sun gear 31 as an external gear; a ring gear 32 as an internal gear that is disposed concentrically with the sun gear 31; and a planetary carrier 34 holding in a rotatable and revolvable manner a plurality of sets of two pinion gears 33a, 33b meshing with each other, one of the pinion gears 33a, 33b meshing with the sun gear 31, and the other meshing with the ring gear 32. As shown in the figure, the sun gear 31 of the first planetary gear mechanism 30 is fixed to the transmission case 22, and the planetary carrier 34 of the first planetary gear mechanism 30 is connected to the input member 26 so as to be rotatable together with the input member 26. The first planetary gear mechanism 30 is configured as a so-called reduction gear, which reduces the speed of power transmitted to the planetary carrier 34 as an input element to output the resultant power from the ring gear 32 as an output element.

The second planetary gear mechanism 35 has: a first sun gear 36a and a second sun gear 36b as external gears; a ring gear 37 as an internal gear that is disposed concentrically with the first and second sun gears 36a, 36b and that functions as an output member of the automatic transmission 25; a plurality of short pinion gears 38a meshing with the first sun gear 36a; a plurality of long pinion gears 38b meshing with the second sun gear 36b and the plurality of short pinion gears 38a and meshing with the ring gear 37; and a planetary carrier 39 holding in a rotatable and revolvable manner the plurality of short pinion gears 38a and the plurality of long pinion gears 38b. The ring gear 37 of the second planetary gear mechanism 35 is coupled to the gear mechanism 40 via a coupling member 60, and power from the automatic transmission 25 is transmitted to the right and left drive wheels DW via the gear mechanism 40, the differential gear 50, and a drive shaft 28. The planetary carrier 39 of the second planetary gear mechanism 35 is supported by the transmission case 22 via the one-way clutch F1.

The clutch C1 is a hydraulic clutch (friction engagement element) capable of connecting and disconnecting the ring gear 32 of the first planetary gear mechanism 30 to and from the first sun gear 36a of the second planetary gear mechanism 35. The clutch C2 is a hydraulic clutch capable of connecting and disconnecting the input member 26 to and from the planetary carrier 39 of the second planetary gear mechanism 35. The clutch C3 is a hydraulic clutch capable of connecting and disconnecting the ring gear 32 of the first planetary gear mechanism 30 to and from the second sun gear 36b of the second planetary gear mechanism 35. The clutch C4 is a hydraulic clutch capable of connecting and disconnecting the planetary carrier 34 of the first planetary gear mechanism 30 to and from the second sun gear 36b of the second planetary gear mechanism 35. The brake B1 is a hydraulic brake (friction engagement element) capable of holding the second sun gear 36b of the second planetary gear mechanism 35 stationary with respect to the transmission case 22 as well as allowing the second sun gear 36b to rotate with respect to the transmission case 22. The brake B2 is a hydraulic brake capable of holding the planetary carrier 39 of the second planetary gear mechanism 35 stationary with respect to the transmission case 22 as well as allowing the planetary carrier 39 to rotate with respect to the transmission case 22.

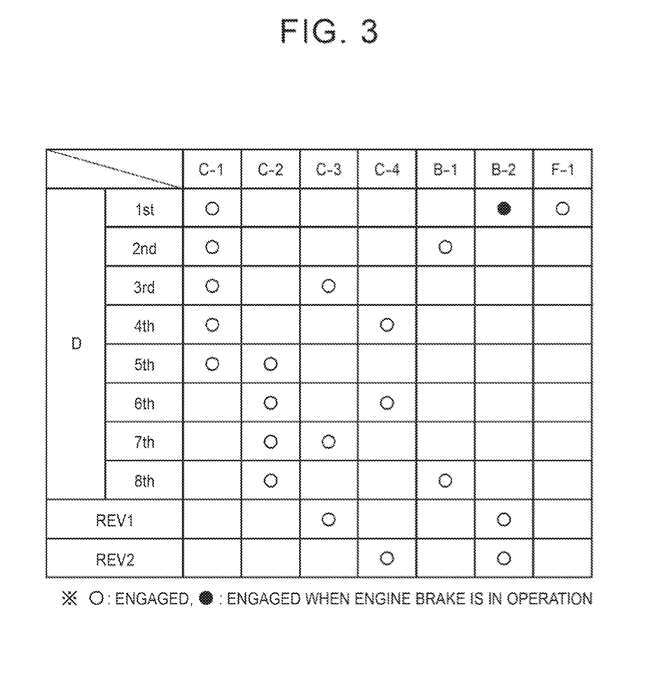

The clutches C1 to C4 and the brakes B1, B2 operate with hydraulic oil supplied thereto and discharged therefrom by the hydraulic control device, not shown. FIG. 3 shows an operation table showing the relation between each shift speed of the automatic transmission 25 and the operating state of the clutches C1 to C4, the brakes B1, B2, and the one-way clutch F1. The automatic transmission 25 attains first to eighth forward speeds and first and second reverse speeds by bringing the clutches C1 to C4, the brakes B1, B2 and the one-way clutch F1 into the states shown in the operation table of FIG. 3. At least one of the clutches C1 to C4 and the brakes B1, B2 may be a meshing engagement element such as a dog clutch.

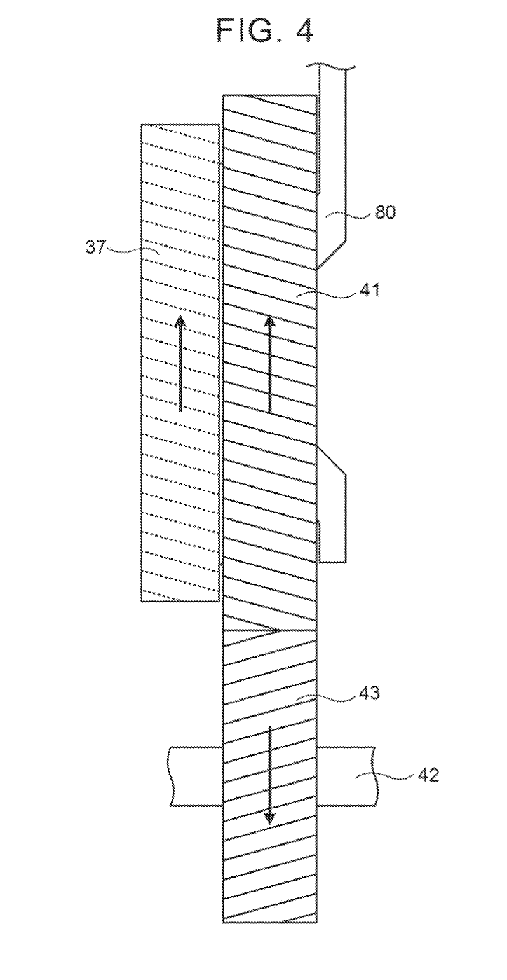

FIG. 4 is a schematic view schematically showing the ring gear 37 of the second planetary gear mechanism 35, a counter drive gear 41, and a counter driven gear 43. Since the ring gear 37 is an internal gear, teeth of the ring gear 37 are shown by dotted lines. In the figure, arrows represent the rotational direction of each gear during forward traveling. Although only the ring gear 37 is shown in FIG. 4, each gear of the first planetary gear mechanism 30 and the second planetary gear mechanism 35 of the automatic transmission 25 is configured as a helical gear, and meshes with a corresponding gear so that a rightward force in FIG. 4 is applied to the ring gear 37 as the output member during forward traveling.

As shown in FIG. 2, the gear mechanism 40 has: the counter drive gear 41 that is coupled to the ring gear 37 of the second planetary gear mechanism 35 of the automatic transmission 25 via the coupling member 60; the counter driven gear 43 that is fixed to a countershaft 42 extending parallel to the input member 26 of the automatic transmission 25 and that meshes with the counter drive gear 41; a drive pinion gear (final drive gear) 44 formed on (or fixed to) the countershaft 42; and a differential ring gear (final driven gear) 45 that meshes with the drive pinion gear 44 and that is coupled to the differential gear 50. The ring gear 37 and the coupling member 60 are coupled by spline fitting along their entire circumference, and the coupling member 60 and the counter drive gear 41 are coupled by spline fitting along their entire circumference.

As shown in FIG. 4, the counter drive gear 41 and the counter driven gear 43 is configured as helical gears, and mesh with each other so that a radially inward force and a leftward force in FIG. 4 (a force in the direction toward the ring gear 37 of the automatic transmission 25) are applied from the counter driven gear 43 to the counter drive gear 41 during forward traveling. The counter drive gear 41 is rotatably supported via a bearing 61 by a center support 80 fixed to the transmission case 22.

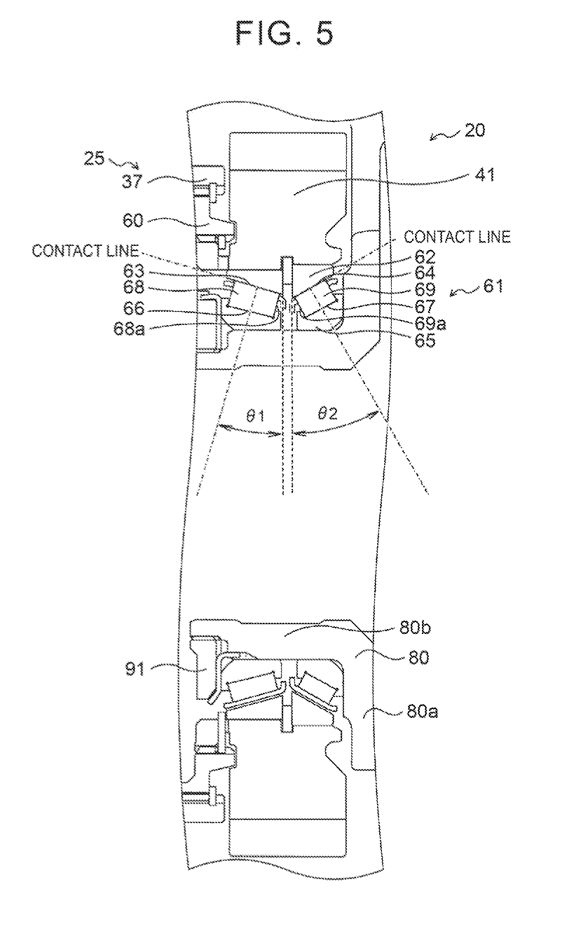

FIG. 5 is a partial enlarged view showing the counter drive gear 41 and the bearing 61 in the power transmission device 20. The bearing 61 is configured as a double row tapered roller bearing with back-to-back duplex type, and includes: an outer race 62 as an outer ring having an annular shape, coupled at its outer periphery to the inner periphery of the counter drive gear 41, and having two rows of outer ring raceways 63, 64 formed on its inner periphery; an inner race 65 as an inner ring having an annular shape, coupled at its inner periphery to the outer periphery of the center support 80, and having two rows of inner ring raceways 66, 67 formed on its outer periphery; tapered rollers (conical rollers) 68, 69 as two rows of a plurality of rolling elements that roll between the two rows of the outer ring raceways 63, 64 of the outer race 62 and the two rows of the inner ring raceways 66, 67 of the inner race 65; and a cage, not shown, that retains the plurality of tapered rollers 68, 69 so that the tapered rollers 68, 69 do not contact each other in each row. Hereinafter, one of the two rows which is located closer to the ring gear 37 of the automatic transmission 25 is referred to as the first row, and the other located on the opposite side is referred to as the second row.

The plurality of tapered rollers 69 of the second row are smaller than the plurality of tapered rollers 68 of the first row. The plurality of tapered rollers 68 of the first row contact the outer ring raceway 63 of the outer race 62 and the inner ring raceway 66 of the inner race 65 so that their contact angle θ with the outer ring raceway 63 and the inner ring raceway 66 is a relatively small angle θ1 (e.g., 15 degrees, 20 degrees, etc.). The plurality of tapered rollers 69 of the second row contact the outer ring raceway 64 of the outer race 62 and the inner ring raceway 67 of the inner race 65 so that their contact angle θ with the outer ring raceway 64 and the inner ring raceway 67 is an angle θ2 larger than the angle θ1 (e.g., 25 degrees, 30 degrees, etc.). In the embodiment, the contact angle θ refers to an angle of a straight line (dash-dot straight line in FIG. 5), which lies on a plane perpendicular to a contact line of the tapered roller 68, 69 with the outer ring raceway 63, 64 and extends toward the centerline of the bearing 61, with respect to the radially inward direction (dashed straight line in FIG. 5).

In the power transmission device 20, as shown in FIG. 5, the center support 80 includes a wall portion 80a extending radially inward from the inner periphery of the transmission case 22, and a cylindrical portion 80b extending leftward in FIG. 5 in the axial direction from an inner peripheral portion of the wall portion 80a. A nut 91 is screwed on a threaded portion formed on the left end in FIG. 5 of the cylindrical portion 80b of the center support 80. The right end face in FIG. 5 of the inner race 65 contacts the wall portion 80a of the center support 80, and the left end face in FIG. 5 of the inner race 65 is pressed to the right in FIG. 5 via a washer by the nut 91. That is, the bearing 61 is fixed by the wall portion 80a of the center support 80 and the nut 91 so that the bearing 61 cannot move in the axial direction (lateral direction in FIG. 5) with respect to the center support 80.

In the power transmission device 20 of the embodiment thus configured, a rightward force in FIG. 5 (hereinafter referred to as the “external thrust force”) is applied from the ring gear 37 of the automatic transmission 25 to the counter drive gear 41 along its entire circumference via the coupling member 60 during forward traveling. At this time, the resultant force of an upward (radially inward) force in FIG. 5 (hereinafter referred to as the “meshing radial force”) and a leftward force in FIG. 5 (hereinafter referred to as the “meshing thrust force”) is applied from the counter driven gear 43 to a meshing part of the counter drive gear 41 with the counter driven gear 43 (the lower part in FIG. 5), and a rightward force in FIG. 5 (hereinafter referred to as the “meshing reaction force”) as a reaction force to the meshing thrust force is applied to a part of the counter drive gear 41 which is located on the opposite side from the meshing part with respect to the gear center (the upper part in FIG. 5, hereinafter referred to as the “opposite-side part”). The external thrust force is produced as each gear of the first planetary gear mechanism 30 and the second planetary gear mechanism 35 of the automatic transmission 25 is configured as a helical gear and the ring gear 37 and the counter drive gear 41 are coupled along their entire circumference. The resultant force of the meshing radial force and the meshing thrust force and the meshing reaction force are produced as the counter drive gear 41 and the counter driven gear 43 are configured as helical gears and partially mesh with each other. Accordingly, the plurality of tapered rollers 68 of the first row need be designed in view of the resultant force of the meshing radial force, the meshing thrust force, and the external thrust force in the lower part in FIG. 5, and the plurality of tapered rollers 69 of the second row need be designed in view of the resultant force of the meshing reaction force and the external thrust force in the upper part in FIG. 5.

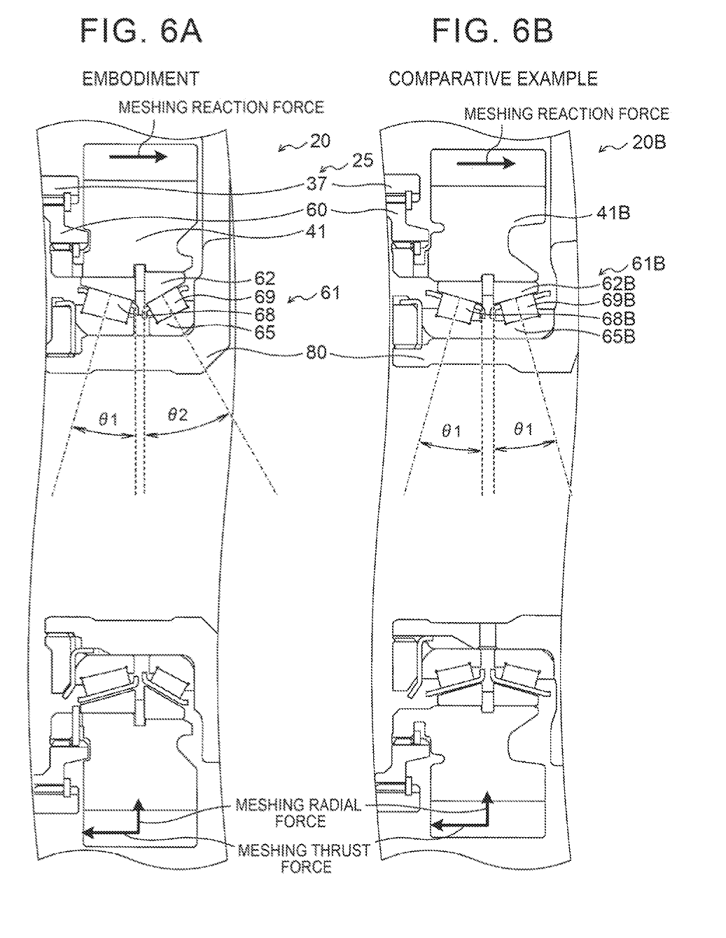

FIG. 6 shows schematic configuration diagrams schematically showing the configuration of the counter drive gears 41, 41B and the bearings 61, 61B in the power transmission device 20 of the present embodiment and a power transmission device 20B of a comparative example. The elements of the bearing 61B of the comparative example correspond to the elements of the bearing 61 of the embodiment except the letter “B.” FIG. 6A schematically shows the configuration of the embodiment, and FIG. 6B schematically shows the configuration of the comparative example in which both the contact angle θ in the first row and the contact angle θ in the second row are the angle θ1. In the comparative example, since the contact angle θ in the second row is the relatively small angle θ1, a plurality of tapered rollers 69B of the second row need to have a certain size in order to ensure rigidity against the resultant force of the meshing reaction force and the external thrust force, and the same tapered rollers as a plurality of tapered rollers 68B of the first row are typically used as the plurality of tapered rollers 69B. On the other hand, in the present embodiment, the contact angle θ in the second row (angle θ2) is made larger than the contact angle θ in the first row (angle θ1), which allows the opposite-side part of the counter drive gear 41 to have increased rigidity against the resultant force of the meshing reaction force and the external thrust force. This can further suppress tilting of the counter drive gear 41 with respect to a perpendicular plane perpendicular to the axial direction, and can achieve reduction in gear noise etc. The tapered rollers 69 can be made smaller than the tapered rollers 68 in such a range that the rigidity against the resultant force of the meshing reaction force and the external thrust force can be ensured. The axial size of the bearing 61 can thus be reduced by reducing the size of the tapered rollers 69. It is preferable that the contact angle θ in the first row be the relatively small angle θ1 in order to ensure a torque transfer function during forward traveling. That is, it is not preferable to use a large contact angle θ in the first row, because increasing the contact angle θ in the first row reduces rigidity against a radially inward force (radial load) and thus the size of the tapered rollers 68 need be increased in order to ensure the torque transfer function.

According to the power transmission device 20 of the above embodiment, in the configuration in which the counter drive gear 41 meshes with the counter driven gear 43 so that the resultant force of a radially inward force and a force in the direction toward the automatic transmission 25 is applied from the counter driven gear 43 to the counter drive gear 41 during forward traveling, the bearing 61 is formed so that the contact angle θ (angle θ2) of the plurality of tapered rollers 69 of the second row located on the side farther from the automatic transmission 25 with the outer ring raceway 64 of the outer race 62 and the inner ring raceway 67 of the inner race 65 is larger than the contact angle θ (angle θ1) of the plurality of tapered rollers 68 of the first row located on the side closer to the automatic transmission 25 with the outer ring raceway 63 of the outer race 62 and the inner ring raceway 66 of the inner race 65. This can further suppress tilting of the counter drive gear 41 with respect to the perpendicular plane perpendicular to the axial direction, and can achieve reduction in gear noise etc. Reduction in size of the tapered rollers 69 can also be achieved.

In the power transmission device 20 of the embodiment, the plurality of tapered rollers 69 of the second row are smaller than the plurality of tapered rollers 68 of the first row. However, the plurality of tapered rollers 69 of the second row may have the same size as the plurality of tapered rollers 68 of the first row.

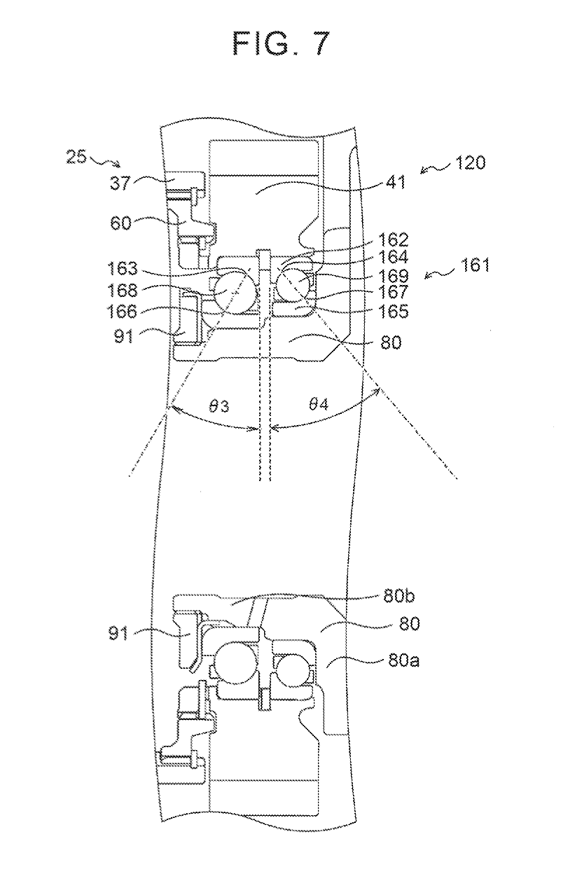

In the power transmission device 20 of the embodiment, a double row tapered roller (conical roller) bearing is used as the bearing 61. However, a double row roller (cylindrical roller) bearing may be used as the bearing 61, or a double row ball bearing may be used as the bearing 61. FIG. 7 is a partial enlarged view showing the counter drive gear 41 and a bearing 161 in a power transmission device 120 using a double row ball bearing.

The bearing 161 is configured as a double row ball bearing with back-to-back duplex type and includes: an outer race 162 as an outer ring having an annular shape, coupled at its outer periphery to the inner periphery of the counter drive gear 41, and having two rows of outer ring raceways 163, 164 formed on its inner periphery; an inner race 165 as an inner ring having an annular shape, coupled at its inner periphery to the outer periphery of the center support 80, and having two rows of inner ring raceways 166, 167 formed on its outer periphery; balls 168, 169 as two rows of a plurality of rolling elements that roll between the two rows of the outer ring raceways 163, 164 of the outer race 162 and the inner ring raceways 166, 167 of the inner race 165; and a cage, not shown, that retains the plurality of balls 168, 169 so that the balls 168, 169 do not contact each other in each row.

The plurality of balls 169 of the second row (on the opposite side from the ring gear 37) are smaller than the plurality of balls 168 of the first row (on the ring gear 37 side). The plurality of balls 168 of the first row contact the outer ring raceway 163 of the outer race 162 and the inner ring raceway 166 of the inner race 165 so that their contact angle θ with the outer ring raceway 163 and the inner ring raceway 166 is a relatively small angle θ3 (e.g., 25 degrees, 30 degrees, etc.). The plurality of balls 169 of the second row contact the outer ring raceway 164 of the outer race 162 and the inner ring raceway 167 of the inner race 165 so that their contact angle θ with the outer ring raceway 164 and the inner ring raceway 167 is an angle θ4 larger than the angle θ3 (e.g., 35 degrees, 40 degrees, etc.). In this modification, the contact angle θ refers to an angle of a straight line (dash-dot straight line in FIG. 7), which passes through the contact point of the ball 168, 169 with the outer ring raceway 163, 164 and the contact point of the ball 168, 169 with the inner ring raceway 166, 167 and extends toward the centerline of the bearing 161, with respect to the radially inward direction (dashed straight line in FIG. 7).

In the power transmission device 120, the center support 80 includes the wall portion 80a and the cylindrical portion 80b as in the power transmission device 20 of the embodiment. The nut 91 is screwed on a threaded portion formed on the left end in FIG. 7 of the cylindrical portion 80b of the center support 80. As in the bearing 61 of the embodiment, the right end face in FIG. 7 of the inner race 165 contacts the wall portion 80a of the center support 80, and the left end face in FIG. 7 of the inner race 165 is pressed to the right in FIG. 7 via a washer by the nut 91. That is, the bearing 161 is fixed by the wall portion 80a of the center support 80 and the nut 91 so that the bearing 161 cannot move in the axial direction (lateral direction in FIG. 7) with respect to the center support 80.

As in the power transmission device 20 of the embodiment, in the power transmission device 120 of the modification thus configured, the contact angle θ in the second row (angle θ4) is made larger than the contact angle θ in the first row (angle θ3), which allows the opposite-side part of the counter drive gear 41 to have increased rigidity against the resultant force of the meshing reaction force and the external thrust force, as compared to the case where both the contact angle θ in the first row and the contact angle θ in the second row are the angle θ3. This can further suppress tilting of the counter drive gear 41 with respect to the perpendicular plane perpendicular to the axial direction, and can achieve reduction in gear noise etc. The balls 169 can be made smaller than the balls 168 in such a range that the rigidity against the resultant force of the meshing reaction force and the external thrust force can be ensured. The axial size of the bearing 161 can thus be reduced by reducing the size of the balls 169. It is preferable that the contact angle θ in the first row be the relatively small angle θ3 in order to ensure a torque transfer function during forward traveling. That is, it is not preferable to use a large contact angle θ in the first row, because increasing the contact angle θ in the first row reduces rigidity against a radially inward force (radial load) and thus the size of the balls 168 need be increased in order to ensure the torque transfer function.

In this modification, the plurality of balls 169 of the second row are smaller than the plurality of balls 168 of the first row. However, the plurality of balls 169 of the second row may have the same size as the plurality of balls 168 of the first row.

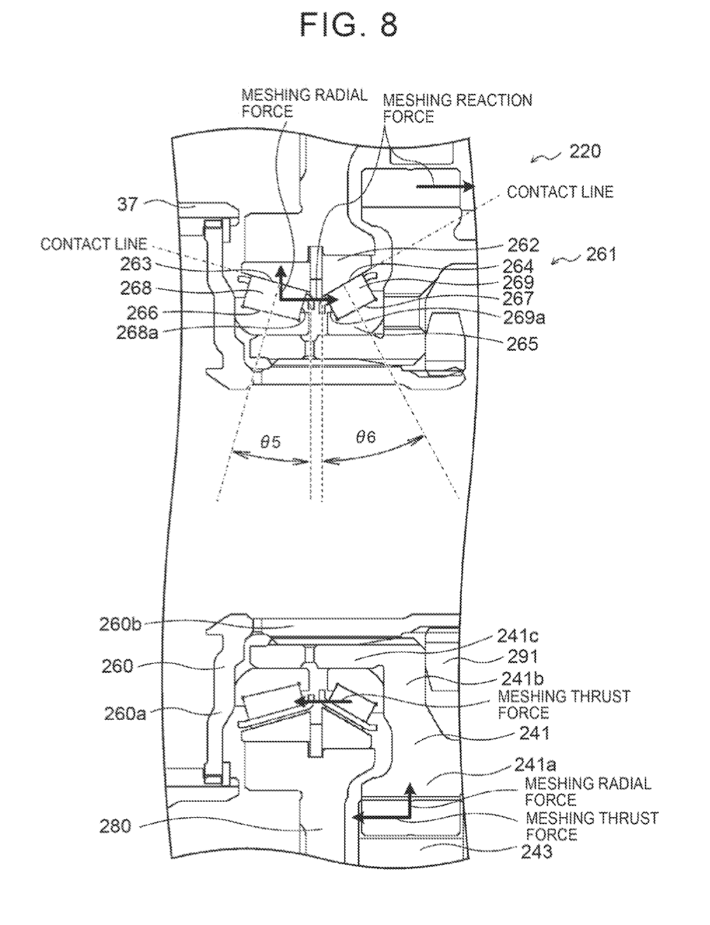

In the power transmission device 20 of the embodiment, the outer race 62 is coupled to the counter drive gear 41, and the inner race 65 is coupled to the center support 80. However, the outer race 62 may be coupled to the center support 80, and the inner race 65 may be coupled to the counter drive gear 41. FIG. 8 is a partial enlarged view showing a counter drive gear 241 and a bearing 261 in such a power transmission device 220.

In the power transmission device 220, a coupling member 260 includes a wall portion 260a coupled to the ring gear 37 and extending in the radial direction, and a cylindrical portion 260b extending rightward in FIG. 8 in the axial direction from an inner peripheral portion of the wall portion 260a. The counter drive gear 241 includes a gear portion 241a having gear teeth on its outer periphery, a support portion 241b extending radially inward from the inner periphery of the gear portion 241a, and a cylindrical portion 241c extending leftward in FIG. 8 in the axial direction from an inner peripheral portion of the support portion 241b. The counter drive gear 241 is rotatably supported by a center support 280 via the bearing 261. The coupling member 260 and the counter drive gear 241 are coupled by spline fitting the cylindrical portion 241c of the counter drive gear 241 on the cylindrical portion 260b of the coupling member 260 along their entire circumference. A nut 291 is screwed on a threaded portion formed on the right end in FIG. 8 of the cylindrical portion 260b of the coupling member 260.

The bearing 261 is configured as a double row tapered roller bearing with back-to-back duplex type, and includes: an outer race 262 as an outer ring having an annular shape, coupled at its outer periphery to the inner periphery of the center support 280, and having two rows of outer ring raceways 263, 264 formed on its inner periphery; an inner race 265 as an inner ring having an annular shape, coupled at its inner periphery to the outer periphery of the cylindrical portion 241c of the counter drive gear 241, and having two rows of inner ring raceways 266, 267 formed on its outer periphery; tapered rollers (conical rollers) 268, 269 as two rows of a plurality of rolling elements that roll between the two rows of the outer ring raceways 263, 264 of the outer race 262 and the inner ring raceways 266, 267 of the inner race 265; and a cage, not shown, that retains the plurality of tapered rollers 268, 269 so that the tapered rollers 268, 269 do not contact each other in each row.

The plurality of tapered rollers 269 of the second row (on the opposite side from the ring gear 37) are smaller than the plurality of tapered rollers 268 of the first row (on the ring gear 37 side). The plurality of tapered rollers 268 of the first row contact the outer ring raceway 263 of the outer race 262 and the inner ring raceway 266 of the inner race 265 so that their contact angle θ with the outer ring raceway 263 and the inner ring raceway 266 is a relatively small angle θ5 (e.g., 15 degrees, 20 degrees, etc.). The plurality of tapered rollers 269 of the second row contact the outer ring raceway 264 of the outer race 262 and the inner ring raceway 267 of the inner race 265 so that their contact angle θ with the outer ring raceway 264 and the inner ring raceway 267 is an angle θ6 larger than the angle θ5 (e.g., 25 degrees, 30 degrees, etc.). The definition of the contact angle θ is similar to that in the embodiment.

Both end faces in the axial direction of the inner race 265 are pressed by the wall portion 260a of the coupling member 260 and by the support portion 241b of the counter drive gear 241 via the nut 291. That is, the bearing 261 is fixed by the wall portion 260a of the coupling member 260, the support portion 241b of the counter drive gear 241, and the nut 291 so that the bearing 261 cannot move in the axial direction (lateral direction in FIG. 8) with respect to the coupling member 260 and the counter drive gear 241.

In the power transmission device 220 of the modification thus configured, during forward traveling, the resultant force of an upward meshing radial force in FIG. 8 and a leftward meshing thrust force in FIG. 8 is applied from the counter driven gear 243 to a meshing part of the counter drive gear 241 with the counter driven gear 243 (the lower part in FIG. 8), and a rightward meshing reaction force in FIG. 8 as a reaction force to the meshing thrust force is applied to the opposite-side part of the counter drive gear 41 which is located on the opposite side from the meshing part with respect to the gear center (the upper part in FIG. 8). The cylindrical portion 241c of the counter drive gear 241 presses the bearing 261 upward in FIG. 8 by the meshing radial force. Moreover, in the lower part in FIG. 8, the plurality of tapered rollers 269 of the second row (on the opposite side from the ring gear 37) are subjected to the meshing thrust force via the support portion 241b of the counter drive gear 241. In the upper part in FIG. 8, however, the plurality of tapered rollers 269 of the second row are not subjected to the meshing reaction force because these tapered rollers 269 are located on the opposite side of the support portion 241b with respect to the direction of the meshing reaction force. Accordingly, the plurality of tapered rollers 268 of the first row (on the ring gear 37 side) need be designed in view of the resultant force of the meshing radial force and the meshing thrust force in the upper part in FIG. 8, and the plurality of tapered rollers 269 of the second row (on the opposite side from the ring gear 37) need be designed in view of the meshing thrust force in the lower part in FIG. 8. In view of this, in this modification, the contact angle θ in the first row is the relatively small angle θ5, and the contact angle θ in the second row is the angle θ6 larger than the angle θ5. Rigidity against the axial force that is applied to the counter drive gear 241 can thus be increased as compared to the case where both the contact angle θ in the first row and the contact angle θ in the second row are the angle θ5. This can further suppress tilting of the counter drive gear 41 with respect to the perpendicular plane perpendicular to the axial direction, and can achieve reduction in gear noise etc. The tapered rollers 269 can be made smaller than the tapered rollers 268 in such a range that rigidity against the meshing thrust force can be ensured. The axial size of the bearing 261 can thus be reduced by reducing the size of the tapered rollers 269. It is preferable that the contact angle θ in the first row be the relatively small angle θ5 for a reason similar to that in the embodiment.

According to the power transmission device 220 of this modification, as in the embodiment, the bearing 261 is formed so that the contact angle θ (angle θ6) of the plurality of tapered rollers 269 of the second row located on the side farther from the automatic transmission 25 with the outer ring raceway 264 of the outer race 262 and the inner ring raceway 267 of the inner race 265 is larger than the contact angle θ (angle θ5) of the plurality of tapered rollers 268 of the first row located on the side closer to the automatic transmission 25 with the outer ring raceway 263 of the outer race 262 and the inner ring raceway 266 of the inner race 265. This can further suppress tilting of the counter drive gear 241 with respect to the perpendicular plane perpendicular to the axial direction, and can achieve reduction in gear noise etc. Reduction in size of the tapered rollers 269 can also be achieved.

In the power transmission device 220 of this modification, the plurality of tapered rollers 269 of the second row are smaller than the plurality of tapered rollers 268 of the first row. However, the plurality of tapered rollers 269 of the second row may have the same size as the plurality of tapered rollers 268 of the first row.

In the power transmission device 220 of this modification, a double row tapered roller (conical roller) bearing is used as the bearing 261. However, a double row roller (cylindrical roller) bearing may be used as the bearing 261, or a double row ball bearing may be used as the bearing 261.

The power transmission device 20 of the embodiment uses the bearing 61 configured as a double row tapered roller bearing with back-to-back duplex type, the power transmission device 120 of the modification uses the bearing 161 configured as a double row ball bearing with back-to-back duplex type, and the power transmission device 220 of the modification uses the bearing 261 configured as a double row tapered roller bearing with back-to-back duplex type. However, a double row tapered roller bearing or double row ball bearing with face-to-face duplex type may be used.

In the power transmission device 20 of the embodiment and the power transmission devices 120, 220 of the modifications, the directions of the helical teeth of the gears of the first planetary gear mechanism 30 and the second planetary gear mechanism 35 of the automatic transmission 25, the counter drive gear 41, and the counter driven gear 43 are determined so that a rightward force in FIG. 5 is applied as the external thrust force from the ring gear 37 of the automatic transmission 25 to the counter drive gear 41 along its entire circumference and a leftward force in FIG. 5 is applied as the meshing thrust force from the counter driven gear 43 to the meshing part during forward traveling. However, the directions of the helical teeth of the gears of the first planetary gear mechanism 30 and the second planetary gear mechanism 35 of the automatic transmission 25, the counter drive gear 41, and the counter driven gear 43 may be determined so that a leftward force in FIG. 5 is applied as the external thrust force from the ring gear 37 to the counter drive gear 41 along its entire circumference and a rightward force in FIG. 5 is applied as the meshing thrust force from the counter driven gear 43 to the meshing part during forward traveling. In this case, the bearings 61, 161, 261 need only be formed so that the contact angle θ in the row located on the side closer to the automatic transmission 25 is larger than that in the row located on the side farther from the automatic transmission 25.

Correspondence between the main elements of the embodiment and the main elements of the disclosure described in the section “SUMMARY” will be described. In the embodiment, the automatic transmission 25 is an example of the “transmission,” the bearing 61 is an example of the “bearing,” the counter drive gear 41 is an example of the “counter drive gear,” and the counter driven gear 43 is an example of the “counter driven gear.”

Since the embodiment is shown by way of example in order to specifically describe the mode for carrying out the disclosure described in the section “SUMMARY,” the correspondence between the main elements of the embodiment and the main elements of the disclosure described in the section “SUMMARY” is not intended to limit the elements of the disclosure described in the section “SUMMARY.” That is, the disclosure described in the section “SUMMARY” should be construed based on the description in the section “SUMMARY,” and the embodiment is merely a specific example of the disclosure described in the section “SUMMARY.”

Although the mode for carrying out the present disclosure is described above by using the embodiment, it should be understood that the present disclosure is not limited in any respect to the embodiment, and can be carried out in various forms without departing from the spirit and scope of the present disclosure.

### INDUSTRIAL APPLICABILITY

The present disclosure is applicable to the manufacturing industry of power transmission devices etc.

1. A power transmission device, comprising:
a transmission,
a case member
a bearing,
a counter drive gear that is coupled to an output member of the transmission, that is rotatably supported by the case member via the bearing, and that is formed by a helical gear, and
a counter driven gear that meshes with the counter drive gear so that a resultant force of a radially inward force and a force in one direction in an axial direction is applied to the counter drive gear during forward traveling of a vehicle, wherein
the bearing is provided between the counter drive gear and the case member, and includes an outer ring having an annular shape and having two rows of outer ring raceways formed on its inner periphery, an inner ring having an annular shape and having two rows of inner ring raceways formed on its outer periphery, and two rows of a plurality of rolling elements that roll between the two rows of outer ring raceways and the two rows of inner ring raceways, and
the bearing is formed so that a second row contact angle of the plurality of rolling elements of a second row with the outer ring raceway and the inner ring raceway is larger than a first row contact angle of the plurality of rolling elements of a first row with the outer ring raceway and the inner ring raceway, the first row being one of the two rows which is located on a side in the one direction, and the second row being the other row different from the first row.

2. The power transmission device according to claim 1, wherein
the plurality of rolling elements of the second row are smaller than the plurality of rolling elements of the first row.

3. The power transmission device according to claim 2, wherein
the one direction is a direction toward the output member of the transmission, and
the output member is formed by a helical gear, and is subjected to a force in the other direction in the axial direction which is opposite to the one direction.

4. The power transmission device according to claim 3, wherein
the bearing is configured as a tapered roller bearing.

5. The power transmission device according to claim 4, wherein
the bearing is configured as a double row bearing with back-to-back duplex type, and
the inner ring is fixed so that it cannot move in the axial direction with respect to the case member or the counter drive gear.

6. The power transmission device according to claim 5, wherein
the outer ring of the bearing is coupled to the counter drive gear, and the inner ring of the bearing is coupled to the case member, and
the inner ring is fixed so that it cannot move in the axial direction with respect to the case member.

7. The power transmission device according to claim 5, wherein
the outer ring of the bearing is coupled to the case member, and the inner ring of the bearing is coupled to the counter drive gear, and
the inner ring is fixed so that it cannot move in the axial direction with respect to the counter drive gear.

8. The power transmission device according to claim 1, wherein
the one direction is a direction toward the output member of the transmission, and
the output member is formed by a helical gear, and is subjected to a force in the other direction in the axial direction which is opposite to the one direction.

9. The power transmission device according to claim 1, wherein
the bearing is configured as a tapered roller bearing.

10. The power transmission device according to claim 1, wherein
the bearing is configured as a double row bearing with back-to-back duplex type, and
the inner ring is fixed so that it cannot move in the axial direction with respect to the case member or the counter drive gear.

11. The power transmission device according to claim 10, wherein
the outer ring of the bearing is coupled to the counter drive gear, and the inner ring of the bearing is coupled to the case member, and
the inner ring is fixed so that it cannot move in the axial direction with respect to the case member.

12. The power transmission device according to claim 10, wherein
the outer ring of the bearing is coupled to the case member, and the inner ring of the bearing is coupled to the counter drive gear, and
the inner ring is fixed so that it cannot move in the axial direction with respect to the counter drive gear.
